(19) United States
(12) Patent Application Publication
(10) Pub. No.: US 2006/0077974 A1
(43) Pub. Date: Apr. 13, 2006

(54) Return path derivation in packet-switched networks

(75) Inventors: Kees Gerard Willem Goossens, Eindhoven (NL); Edwin Rijpkema, Eindhoven (NL); Paul Wielage, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/539,199

(22) PCT Filed: Nov. 18, 2003
(86) PCT No.: PCT/IB03/05261

§ 371 Date: Jun. 17, 2005

(30) Foreign Application Priority Data
Dec. 18, 2002 (EP) 02080356.5

(51) Int. Cl. H04L 12/56

(52) U.S. Cl. 370/389

(57) ABSTRACT

A network for transporting data consists of a group of two or more nodes, such as switches, routers or computer systems, linked together. Data is transported from a source node to a destination node through the network. In packed-switched networks, small units of data called packets are routed through the network from a source node to a destination node. These packets can also be used to program the network. In some cases it is required that the packet travels the return path to the source node. In the present invention, the return path is derived from information stored in the nodes of the network.

### TECHNICAL FIELD

The present invention relates to a method for determining the return path of a packet in a network, the network comprising a plurality of nodes and a plurality of links between the nodes, and wherein for each first node having at least one link with a second node, a link exists between the second node and the first node, the method being used when sending the packet from a source node to a destination node, via at least an intermediate node.

The present invention further relates to an integrated circuit, comprising a network, the network having a plurality of nodes and a plurality of links between the nodes, and wherein for each first node having at least one link with a second node, a link exists between the second node and the first node, the network being arranged to determine the return path of a packet when sending the packet from a source node to a destination node, via at least an intermediate node.

### BACKGROUND ART

In general, a network for transporting data comprises a group of two or more devices, which are referred to as nodes, linked together. The nodes in a network may comprise switches, routers, or computer systems. These computer systems may also have peripheral devices that are necessary to make the computer system function. The communication path between two neighboring nodes in the network is referred to as a link. A link may be implemented by means of a single transmission channel. Alternatively, two links between two nodes can be combined in a single transmission channel. In different networks, two neighboring nodes may have three or more links for communication between these two nodes, in order to increase the bandwidth of the communication. All these links may be implemented in one single transmission channel as well. Data is transported from a source node to a destination node through the network. A network can be used, for example, for communication between several elements assembled on an integrated circuit, or for communication between several computer systems. Data can be transported through the network as a message or as a packet. A message is a user-defined data unit whereas a packet is a network-defined data unit. In so-called message-switched networks messages are routed through the network to their destination, whereas in packet-switched networks, packets are routed through the network to their destination. In case of packet-switched networks, a message that should be sent to a given destination is divided into several packets, which are sent to the destination. At the destination, the packets in a message are collected and reassembled into the original message. An advantage of packet-switched networks is that it allows sharing the same data path among many users in the network at a finer granularity, by breaking down the communication between the source and the destination into relatively smaller data units. In the remainder of this document, the words “packet” and “packet-switched” will be used for reasons of efficiency, but these words can also be read as “message” and “message-switched”.

In packet-switched networks, besides sending data, the packets can also be used to program the network, for example to reserve or free resources, or to set up or remove connections. Examples of resources are the buffer capacity in a router or the bandwidth of a connection. An example of setting up a connection is to set a series of routers in a network such that one or more packets can be sent from a source node to a destination node, via that connection. When sharing the network among many users, an arbitration scheme combines the transmission of the packets over a single transmission channel. For example, Time Division Multiplexing (TDM) can be used, which combines data streams by assigning each stream a different time slot in a set. TDM repeatedly transmits data in a fixed sequence of time slots over a single transmission channel.

In some cases the reservation of resources or set up of a connection, for example, fails because this action cannot be executed in one of the nodes on the path via which the packet is routed. An example is the failure due to a lack of resources such as buffer capacity in a node along the path. As a result, the desired connection can not be set up. Subsequently, reservations, for resources as well as setting up the connection, that have been made until that point of the path may have to be undone. It is therefore essential that the packet revisits the nodes of the path that it has visited before, i.e. it travels the return path to the source node.

US2002/0031095 describes a method to set up the description of the return path, when sending a packet through a network. The network comprises modules that are flexibly networked by means of at least two bi-directional connection interfaces in a physical point-to-point connection in an arbitrary network topology. When a module forwards the packet to another module, the number of the receiving interface of that module is stored in the packet. In this way, the return path can be derived from the list of receiving interfaces stored in the packet and corresponding to the modules that the packet has visited.

It is a disadvantage of the prior art processor that the information on the return path is stored in the packet, which may increase the size of the packet, especially in case of packets containing solely the destination address instead of a complete description of the path through the network.

### DISCLOSURE OF INVENTION

It is an object of the invention to provide an improved method for determining a return path of a packet in a network, which allows reducing the size of the packet.

The object is achieved with a method for determining the return path of packet in a network of the kind set forth, characterized in that the method comprises the step of storing information in the intermediate node for deriving the return path. The information on the return path is stored in nodes that the packet has visited on its path to the destination node. In case a failure occurs, for example, due to not being able to make reservations for resources in a specific node, the packet can derive its return path from the information saved in one or more of the nodes it has visited on its path to the destination node. No additional space is required in the packet to store information on the return path, which allows reducing the size of the packet.

An advantageous embodiment of the invention is characterized in the method further comprises steps of storing information in each node visited by the packet for deriving the return path, when sending the packet from a source node to a destination node, instead of storing the information in only a limited number of nodes visited by the packet or even centrally in only one node. The information on the return path is distributedly saved in the nodes and when travelling the return path, the packet can travel from one node to the other, deriving information on the return path from each node. By storing information on the return path in all the nodes visited by the packet, the overhead for determining the return path can be reduced for each individual node.

An embodiment of the invention is characterized in that the information stored in the intermediate node comprises an identifier of the packet and information that encodes an output port of the intermediate node to be used for returning the packet. An advantage is that this information can be easily derived in the node and uniquely identifies the return path for each packet.

According to the invention, an integrated circuit as defined in the introductory paragraph is characterized in that, the intermediate node is arranged to store information for deriving the return path. As a result, the size of the packets used in an on-chip communication network can be reduced, reducing the communication overhead.

Preferred embodiments of an integrated circuit according to the invention are defined in the dependent claims.

### BRIEF DESCRIPTION OF THE DRAWINGS

FIG. 1 shows an embodiment of a network that uses the method for determining the return path of a packet in a network according to the invention, when sending a packet from a source node to a destination node using destination routing.

FIG. 2 shows an embodiment of a network that uses the method for determining the return path of a packet in a network according to the invention, when sending a packet from a source node to a destination node using source routing.

### DESCRIPTION OF EMBODIMENTS

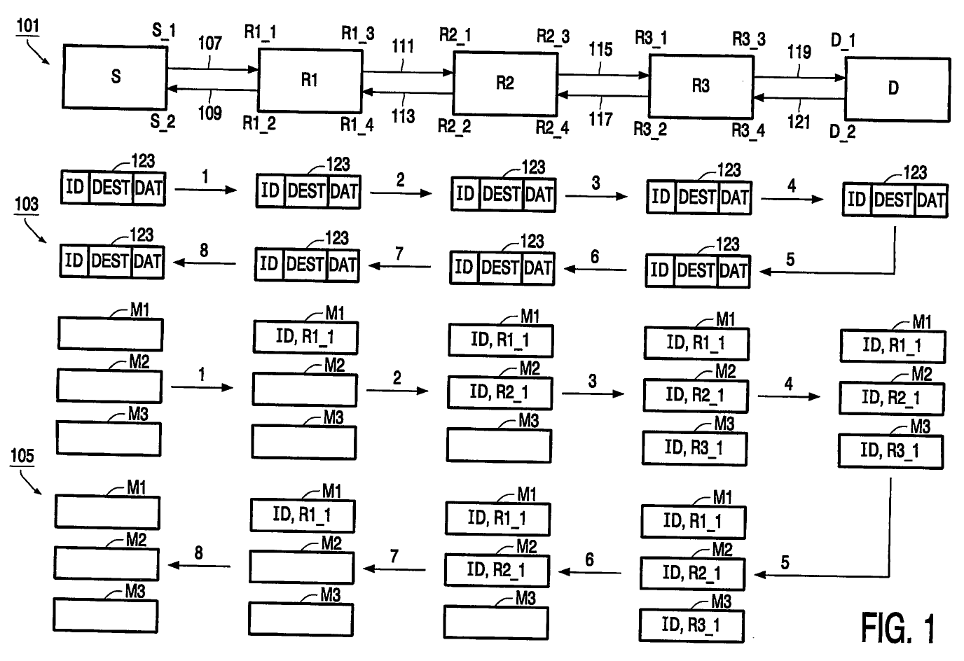

FIG. 1 shows an embodiment of a network that uses the method for determining the return path of a packet in a network according to the invention, when sending a packet from a source node to a destination node using destination routing, i.e. only information on the final destination is stored in the packet. Referring to 101, a network is shown, comprising nodes S, R1, R2, R3 and D, which are coupled with links 107, 109, 111, 113, 115, 117, 119 and 121, via their input ports and output ports S_1, S_2, R1_1, R1_2, R1_3, R1_4, R2_1, R2_2, R2_3, R2_4, R3_1, R3_2, R3_3, R3_4, D_1 and D_2. The network 101 may be a network, or part of a network, of an integrated circuit. The nodes S, R1, R2, R3 and D may comprise routers or switches for sending a unit of data to its next destination. The nodes S, R1, R2, R3 and D may also comprise more input ports and output ports for coupling to other nodes, not shown in FIG. 1. For all nodes S, R1, R2, R3 and D holds that if a first node has at least one link with a second node, also a link exists between the second node and the first node. The nodes S, R1, R2, R3 and D have each stored a return relation, relating each input port of that node to an output port of that node such that when receiving a packet at said input port coming from a specific node, and sending the packet via said output port, it will be send to that specific node. The nodes R1, R2, R3 comprise a memory M1, M2 and M3 respectively. Nodes D and S comprise a memory as well, not shown in FIG. 1. A packet 123 is sent from source node S to destination node D. The packet 123 is being arranged to program the network, e.g. to set-up or to remove connections, or to reserve or free resources, to name a few. An example of setting up a connection is to couple an input port of a certain node to an output port of that node in order to send the packet in the desired direction. Examples of resources are the buffer capacity in a router or the bandwidth of a connection. In case the programming of the network is successful in each node, the packet is routed to the destination node D. However, the programming of the network may fail in a certain node, for example due to a lack of resources, such as buffer capacity. In that case it is essential that the packet travels the return path to the source node S in order to reprogram the network from that certain node onwards to the source node S, for example by releasing resources that were reserved. In this embodiment it is assumed that the programming of the network is successful until destination node D. The packet 123 comprises an identifier ID, a destination address DEST and data DAT used for programming the network. Each node S, R1, R2, R3 and D has stored a destination relation, relating all destinations to the output ports of that node, in order to know which output port to use for sending a packet to a desired destination. Using this information, a node can determine which output port to use in order to send a packet to one of the neighboring nodes, given the destination address DEST of a packet received by that node. Both the destination relation and the return relation can be programmed in a programmable memory present in the nodes S, R1, R2, R3 and D, not shown in FIG. 1, for example. The destination address DEST is equal to the address of destination node D. Referring to 103, the path is shown that the packet 123 follows when sending the packet from source node S to destination node D. Referring to 105, the contents of the memories M1, M2 and M3 are shown, when sending the packet 123 from source node S to destination node D. In a first step 1, the packet 123 is sent by source node S to node R1, via output port S_1, link 107 and input port R1_1. Node R1 reads the identifier ID from the packet 123, and stores it combined with an identifier R1_1 from input port R1_1 in memory M1, as a pair ID, R1_1. Using the destination address DEST stored in packet 123 and its destination relation, node R1 determines which output port to use in order to forward the packet 123, which is output port R1_3. In a next step 2, the packet 123 is sent to node R2, via output port R1_3, link 111 and input port R2_1. Node R2 reads the identifier ID from the packet 123, and stores it combined with an identifier R2_1 from input port R2_1 in memory M2, as a pair ID, R2_1. Using the destination address DEST stored in packet 123 and its destination relation, node R2 determines which output port to use in order to forward the packet, which is output port R2_3. In a next step 3, the packet is sent to node R3, via output port R2_3, link 115 and input port R3_1. Node R3 reads the identifier ID from the packet 123, and stores it combined with an identifier R3_1 from input port R3_1 in memory M3, as a pair ID, R3_1. Using the destination address DEST stored in packet 123 and its destination relation, node R3 determines which output port to use in order to forward the packet, which is output port R3_3. In a next step 4, the packet is sent to destination node D, via output port R3_3, link 119 and input port D_1. Destination node D reads the destination address DEST stored in packet 123, and when comparing with its own address it decides that it is the destination node. In case the programming of the network fails in node D, the packet 123 is returned from destination node D to source node S, using the distributedly saved return path, for reprogramming of the network. Destination node D determines to use output port D_2 for sending the packet 123, from a combination of the identifier D_1 of input port D_1 via which the packet was received and the return relation stored in destination node D. In a next step 5, the packet 123 is sent to node R3, via output port D_2, link 121 and input port R3_4. Node R3 reads the identifier ID from the packet 123, and verifies that this identifier is stored in memory M3 as a pair ID, R3_1. Node R3 determines to use output port R3_2 for sending the packet, from a combination of the identifier R3_1 of input port R3_1 and the return relation stored in node R3. Subsequently, the information stored on the return path in memory M3 in the form of the pair identifier ID and identifier R3_1 is removed. In a next step 6, the packet 123 is sent to node R2, via output port R3_2, link 117 and input port R2_4. Node R2 reads the identifier ID from the packet 123, and detects that this identifier is stored in memory M2 as a pair ID, R2_1. Node R2 determines to use output port R2_2 for sending the packet 123, from a combination of the identifier R2_1 of input port R2_1 and the return relation stored in node R2. Subsequently, the information stored on the return path in memory M2 in the form of the pair identifier ID and identifier R2_1 is removed. In a next step 7, the packet 123 is sent to node R1, via output port R2_2, link 113 and input port R1_4. Node R1 reads the identifier ID from the packet 123, and detects that this identifier is stored in memory M1 as a pair ID, R1_1. Node R1 determines to use output port R1_2 for sending the packet, from a combination of the identifier R1_1 of input port R1_1 and the return relation stored in node R1. Subsequently, the information stored on the return path in memory M1 in the form of the pair identifier ID and identifier R1_1 is removed. In a next step 8, the packet 123 is sent to source node S, via output port R1_2, link 113 and input port S_2. Source node S reads the identifier ID from the packet 123 and determines that it is the final destination of the packet 123 after detecting that the identifier ID is not stored in its internal memory, which is not shown in FIG. 1. In this embodiment, the memories M1, M2 and M3 may comprise a hash table or a content-addressable memory in order to efficiently implement the storage of the pair “identifier of the packet and identifier of the input port”. The memories M1, M2 and M3 may also comprise information on the return path of other packets than packet 123, not shown in FIG. 1.

The information on the return path is derived from the nodes that the packet 123 visits when being routed from the destination node D to the source node S. The information is distributedly saved in the nodes and when travelling the return path, the packet can travel from one node to the other, deriving information on the return path from each node. As a result, no additional space is required in the packet to store information on the return path, which allows reducing the size of the packet.

In other embodiments, the pair “identifier of the packet and identifier of the output port” is stored in the memory M1, M2 and M3 for determination of the return path of the packet 123. The identifier of the output port is determined from the identifier of the input port via which the packet was received by a node and the return relation stored in that node. For example, after step 1 the node R1 reads the identifier ID from the packet 123 and stores it combined with an identifier R1_2 in memory M1, as a pair ID, R1_2. The identifier R1_2 is determined from a combination of the identifier R1_1 of input port R1_1 and the return relation stored in node R1. After sending the packet 123 to node R1 in step 7, node R1 reads the identifier ID from packet 123 and verifies that this identifier is stored in memory M1 as a pair ID, R1_2. Using the identifier R1_2 of output port R1_2 node R1 sends the packet 123 to source node S via output port R1_2, link 109 and input port S_2. In case the number of input ports of the nodes R1, R2 and R3 is larger than the number of output ports, storing the identifiers of the output ports instead of the identifiers of the input ports in memory M1, M2 and M3 for determination of the return path requires less storage space.

In other embodiments, the programming of the network may fail in a certain node before the destination node D is reached. Referring to FIG. 1, in case programming of the network fails in node R3, this node will route the packet 123 to source node S. As already mentioned, is it essential that the packet travels the return path to the source node S in order to reprogram the network. In this embodiment reprogramming of the network involves undoing of reservations that have been made until that point of the path. In different embodiments, reprogramming of the network may also include finding an alternative path to the destination node, during travelling the return path. Node R3 determines to use output port R3_2 for sending the packet from a combination of the identifier R3_1 of input port R3_1 via which the packet 123 was received and the return relation stored in node R3. In a next step 6, the packet is sent to node R2, via output port R3_2, link 117 and input port R2_4. Subsequently, the packet 123 is routed to source node S, as described in a previous embodiment.

In different embodiments, the reprogramming of a network may fail in a certain node, for example because access to a certain resource is denied as it is already being used. Referring to FIG. 1, a packet is routed to destination node D, but the programming of node R3 fails and subsequently the packet is routed to source node S using the information on the return path stored in the nodes R1 and R2, as described in a previous embodiment. The reprogramming of the network fails in node R2, as access to a resource of this node is denied. The node R2 reads the destination address DEST stored in packet 123, and using this destination address and the destination relation it determines to use output port R2_4 for routing the packet to the destination node D. The information on the return path, stored in the form of pair ID, R2_1 in memory M2, remains present in memory M2. In a next step 3, the packet is sent to node R3, via output port R2_3, link 115 and input port R3_1. In node R3, a new attempt is made for programming the network. If this attempt succeeds, the packet 123 is sent to destination node D, as described in a previous embodiment. If the attempt fails, the packet is routed to source node S, as also described in a previous embodiment.

In another embodiment, a different method for deriving an unique identifier of the packet may be used. For example, when using a time-division multiplexing arbitration scheme a slot table is used for a router in order to determine which output port of that router is connected to which unique input port of that router in a given time slot. As a result, a time slot can be used to uniquely identify a packet and to determine the return path, as follows. When travelling from a source node to a destination node, the time slot during which the packet is sent by a node is stored in the packet, and the value of the time slot is increased by one for each node, since it takes one slot to travel between two neighboring nodes. In case the packet has to travel the return path, it is sent to a node, for example to node R2 via input port R2_4. Assuming that the return relation of input port R2_4 is unique, output port R2_3 is uniquely identified by applying the return relation to input port R2_4. Next, using the time slot stored in the packet in combination with the identifier of output port R2_3, the identifier of the input port via which the packet was received when travelling from the source node to the destination node, i.e. R2_1, can be derived from the router table. Next, using the return relation and the identifier of the input port R2_1, the identifier of the output port R2_2 can be determined, and this output port is used for sending the packet in the direction of the source node, i.e. travelling the return path. Prior to sending the packet the value of the time slot stored in the packet is lowered by one.

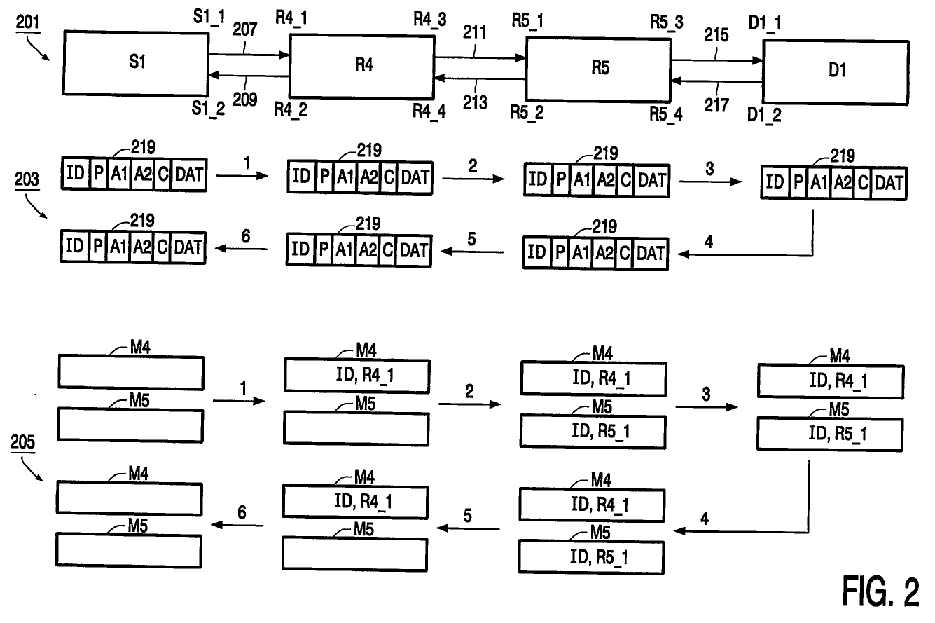

FIG. 2 shows an embodiment of a network that uses the method for determining the return path of a packet in a network according to the invention, when sending a packet from a source node to a destination node using source routing, i.e. the packet comprises information on the routing of that packet. The information on the routing may be stored in the packet in the form of a series of output ports of subsequent nodes, so that each node detects from the packet which output port to use for sending the packet to the next node. While the packet is being routed to a destination node, information on the return path is being stored in the nodes. Referring to 201, a network is shown comprising nodes S1, R4, R5 and D1, which are connected with links 207, 209, 211, 213, 215 and 217, via their input ports and output ports S1_1, S1_2, R4_1, R4_2, R4_3, R4_4, R5_1, R5_2, R5_3, R5_4, D1_1 and D1_2. The network 201 may be a network, or part of a network, of an integrated circuit. The nodes S1, R4, R5 and D1 may comprise routers or switches for sending a unit of data to its next destination. The nodes S1, R4, R5 and D1 may also comprise more input ports and output ports for coupling to other nodes, not shown in FIG. 2. A packet 219 is sent from source node S1 to destination node D1. The nodes R4 and R5 comprise a memory M4 and M5 respectively. Nodes S1 and D1 comprise a memory as well, not shown in FIG. 2. For all nodes S1, R4, R5, and D1 holds that if a first node has at least one link with a second node, also link exists between the second node and the first node. The nodes S1, R4, R5, and D1 have stored a return relation, relating each input port of that node to an output port of that node such that when receiving a packet at said input port coming from a specific node, and sending the packet via said output port, it will be send to that specific node. The packet 219 is being arranged to program the network. In case the programming of the network is successful in each node, the packet is routed to the destination node D. However, the programming of the network may fail in a certain node, for example due to a lack of resources. In that case it is essential that the packet travels the return path to the source node in order to reprogram that part of the network visited so far. In this embodiment it is assumed that the programming of the network is successful until destination node D1. Referring to 203, the path is shown that the packet 219 follows when sending the packet 219 from source node S1 to destination node D1. Referring to 205, the contents of the memories M4 and M5 are shown, when sending the packet from source node S1 to destination node D1. Packet 219 comprises an identifier ID, a pointer P, output port identifiers A1 and A2, a counter C and data DAT. The identifier ID provides for a unique identification of the packet 219. The pointer P points to the location within the packet 219 where the output port identifier is stored of the output port hat should be used for sending the packet. The output port identifiers A1 and A2 uniquely identify the output ports via which the packet should be sent. Counter C determines the total number of nodes that should be passed before reaching the destination node D. The data DAT are used for programming the network. In other embodiments, different encodings for source routing are possible, as known by the person skilled in the art. Before sending the packet 219 from source node S1 to destination node D1, the pointer P is defined such that it points to the location of output port identifier A1 in packet 219. Output port identifier A1 is set equal to the output port identifier R4_3 of output port R4_3, and output port identifier A2 is set to the output port identifier R5_3 of output port R5_3. The counter C is set to 2. In a first step 1, the packet 219 is sent by source node S1 to node R4, via output port S1_1, link 207 and input port R4_1. For selecting the proper output port in order to send the packet 219, the source node S1 must have information about the network it is connected to, for example in the form of a destination relation stored in the node S1. Node R4 reads the value of counter C and detects it is not the destination node, since the value of counter C is not equal to zero. The value of the counter C is lowered by one. Node R4 reads the identifier ID from the packet 219, and stores it combined with the identifier R4_1 from input port R4_1 in memory M4, as a pair ID, R4_1. Node R4 determines to use output port R4_3 for sending the packet 219, by reading the value of pointer P and using that value to read the output port identifier A1. Node R4 updates the pointer P such that it points to the location in packet 219 where output port identifier A2 is stored. In a next step 2, the packet 219 is sent to node R5, via output port R4_3, link 211 and input port R5_1. Node R5 reads the counter C and determines it is not the destination node, since the value of the counter C is not equal to zero. The value of the counter C is lowered by a value of one. Node R5 reads the identifier ID from the packet 219, and stores it combined with the identifier R5_1 from input port R5_1 in memory M5, as a pair ID, R5_1. Node R5 determines to use output port R5_3 for sending the packet 219, by reading the value of pointer P and using that value to read the output port identifier A2. Node R5 determines that the pointer P does not have to be updated, since the value of the counter C is equal to zero. In a next step 3, the packet 219 is sent to node D1, via output port R5_3, link 213 and input port D1_1. Node D1 reads the value of counter C and determines it is the destination node, since the value of counter C is equal to zero. Therefore, the value of C does not have to be updated and the value of pointer P is not read. In case the programming of the network fails in node D1, the packet 219 is routed from destination node D1 to source node S1, using the distributedly saved return path, for reprogramming the network. Node D1 determines to use output port D1_2 for sending the packet 219 back to source node S1, using the identifier D1₁1 of the input port D1_1 via which the packet 219 was received and the return relation stored in node D1. In a next step 4, the packet is sent to node R5, via output port D1_2, link 217 and input port R5_4. Node R5 reads the identifier ID from the packet 219, and detects that this identifier is stored in memory M5 as a pair ID, R5_1. Node R5 determines to use output port R5_2 for sending the packet 219, from a combination of the input port identifier R5_1 of input port R5_1 and the return relation stored in node R5. Node R5 determines that the value of the pointer P does not have to be updated since the value of the counter C is equal to zero. Next, the node R5 increases the counter C by one. The information on the return path stored in memory M5 in the form of the pair identifier ID and identifier R5_1 is removed. In a next step 5, the packet is sent to node R4, via output port R5_2, link 211 and input port R4_4. Node R4 reads the identifier ID from the packet 219, and detects that this identifier is stored in memory M4 as a pair ID, R4_1. Node R4 determines to use output port R4_2 for sending the packet 219, from a combination of the input port identifier R4_1 of input port R4_1 and the return relation stored in node R4. Node R4 updates the pointer P such that it points to the location where output port identifier A1 is stored, and increases the counter C by one. The information on the return path stored in memory M4 in the form of the pair identifier ID and identifier R4_1 is removed. In a next step 6, the packet is sent to node S1, via output port R4_2, link 209 and input port S1_2. Source node S1 read the identifier ID from the packet 219, detects that this identifier is not stored in its internal memory, not shown in FIG. 2, and determines that it is the destination node.

Referring to FIG. 2, in different embodiments the programming of the network may fail in a certain node before the destination node D1 is reached. Referring to FIG. 2, in case programming of the network fails in node R5, this node will route the packet 219 to the source node S1. As already mentioned, is it essential that the packet 219 travels the return path to the source node S1 in order to reprogram the network. Node R5 determines to use output port R5_2 for routing the packet 219 to the source node S1, using the combination of the input port identifier R5_1 of input port R5_1 and the return relation stored in node R5. Node R5 determines that the value of the pointer P does not have to be updated, since the value of the counter C is equal to zero. Node R5 increases the counter C by one. In a next step 5, the packet is sent to node R4, via output port R5_1, link 211 and input port R4_3. Subsequently, the packet 219 is further routed to source node S1, as described in a previous embodiment.

Referring to FIG. 2, in different embodiments the reprogramming of a network may fail, for example because access to a certain resource is denied in a specific node. The packet 219 is routed to destination node D1, but the programming of the network fails in node R5 and subsequently the packet 219 is routed to source node S using the return information stored in the nodes, as described in an earlier embodiment. The packet 219 is sent to node R4. Node R4 updates the pointer P such that it points to the location in the packet 219 where output port identifier Al is stored, and the value of the counter C is increased by one. Next, the reprogramming of the network fails in node R4 and this node routes the packet to destination node D1. Node R4 determines to use output port R4_3 for sending packet 219, by reading the value of pointer P and using that value to read the output port identifier A1. Node R4 updates the pointer P such that it points to the location where output port identifier A2 is stored, and the value of the counter C is decreased by one. In a next step 2, the packet 219 is sent to node R5, via output port R4_3, link 211 and input port R5_1, as described in an earlier embodiment. The information stored in the packet 219 for routing of the packet from source node S1 to destination node D1 remains in the packet 219, while the information on the return path is stored in the nodes R4 and R5. As a result, the packet 219 can be routed more than one time to the destination node D1 via the same path, as described in this embodiment, and each time attempting to program the network.

Referring again to FIG. 1, in different embodiments information on the return path is not stored in all nodes visited by the packet 123 on the path from the source node S to the destination node D. In case a part of the return path is unique and equal to the path the packet travels from source node S to destination node D, no return information has to be stored in the nodes related to that part of the return path. For example, in an embodiment where node R2 has only two input ports R2_1 and R2_4, and two output ports R2_3 and R2_2, no information on the return path is stored in memory M2 of node R2, when sending packet 123 from source node S to destination node D. In case the programming of the network fails in node R3, the packet 123 is routed to the source node S, as described in a previous embodiment. Node R3 sends the packet 123 to node R2, via output port R3_2, link 117 and input port R2_4. Node R2 can only use output port R2_2 for routing the packet 123 to source node S, as can be determined from its destination relation, and sends the packet 123 to node R1, via output port R2_2, link 113 and input port R1_4. Subsequently, node R1 sends the packet 123 to source node S, as described in a previous embodiment. In this embodiment it is assumed that node R2 is not allowed to sent the packet back to node R3, when node R2 has received the packet from node R3 and the reprogramming of the network in node R2 is successful.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A method for determining the return path of a packet in a network, the network comprising a plurality of nodes and a plurality of links between the nodes, and wherein for each first node having at least one link with a second node, a link exists between the second node and the first node,
the method being used when sending the packet from a source node to a destination node, via at least an intermediate node,
characterized in that the method comprises the step of storing information in the intermediate node for deriving the return path.

2. A method for determining the return path of a packet in a network according to claim 1, characterized in that the method further comprises steps of storing information in each node visited by the packet for deriving the return path, when sending the packet from a source node to a destination node.

3. A method for determining the return path of a packet in a network according to claim 1, characterized in that the information stored in the intermediate node comprises an identifier of the packet and information that encodes an output port of the intermediate node to be used for returning the packet.

4. An integrated circuit, comprising a network, the network having a plurality of nodes and a plurality of links between the nodes, and wherein for each first node having at least one link with a second node, a link exists between the second node and the first node, the network being arranged to determine the return path of a packet when sending the packet from a source node to a destination node, via at least an intermediate node, characterized in that, the intermediate node is arranged to store information for deriving the return path.

5. An integrated circuit according to claim 4, characterized in that each node of the plurality of nodes is arranged to store information for deriving the return path.

6. An integrated circuit according to claim 4, characterized in that the intermediate node is arranged to store an identifier of the packet and information that encodes an output port of the intermediate node to be used for returning the packet.
